(19) United States
(12) Patent Application Publication
(10) Pub. No.: US 2009/0040002 A1
(43) Pub. Date: Feb. 12, 2009

(54) Iron Core, Mold and Method of Forming and Laminating the Same

(76) Inventors: Myung-Dae Kim, Gyeonggi-do (KR); Myung-Deuk Kim, Gyeonggi-do (KR); Gap-Gyun Jeong, Incheon (KR)

Correspondence Address: LADAS & PARRY LLP, 26 WEST 61ST STREET, NEW YORK, NY, 10023, US

(21) Appl. No.: 11/887,805

(22) PCT Filed: Apr. 7, 2006
(86) PCT No.: PCT/KR2006/001274

§ 371 Date: Oct. 2, 2007

(30) Foreign Application Priority Data
Apr. 12, 2005 (KR) 10-2005-0030530

(51) Int. Cl. H01F 3/04; H01F 27/24; B21D 28/02

(52) U.S. Cl. 336/234; 29/33 Q; 29/609

(57) ABSTRACT

An iron core built in a transformer, a rectifier, a stabilizer, a lamp, and others is disclosed. When the iron core is formed, an E-shaped iron core and a pair of ⊂-shaped iron cores, which are arranged on both sides of the E-shaped iron core, are simultaneously stamped from a sheet of silicon steel. A predetermined number of E-shaped iron cores and pairs of ⊂-shaped iron cores are assembled and laminated to form a laminated iron core. The iron core includes the E-shaped iron core having side legs symmetrically formed on both sides thereof and a center leg formed between the side legs and coupled to a bobbin around which a coil is wound, and the pair of ⊂-shaped iron cores each having a long leg formed corresponding to the side leg of the E-shaped iron core and a short leg formed corresponding to the center leg of the E-shaped iron core.

### TECHNICAL FIELD

The present invention relates to an iron core, and a mold and a method for forming and laminating the same, whereby an E-shaped iron core and a pair of ⊂-shaped iron cores are continuously formed and laminated, without losing iron material (scrap iron) when the iron core is stamped from a sheet of silicon steel by a press mold.

More particularly, the present invention relates to an iron core which is built in a transformer, a rectifier, a stabilizer, a lamp, and others, and a mold and a method for forming and laminating the iron core, whereby when the iron core is formed, an E-shaped iron core and a pair of ⊂-shaped iron cores, which are arranged on both sides of the E-shaped iron core, are simultaneously stamped from a sheet of silicon steel, and a predetermined number of E-shaped iron cores and pairs of ⊂-shaped iron cores are assembled and laminated to form a laminated iron core.

### BACKGROUND ART

FIG. 1 is a perspective view illustrating the process of forming an iron core according to the related art.

A sheet of silicon steel 1 being continuously fed is stamped by a press mold having a predetermined shape (e.g., a mold and a die each having a shape corresponding to the shape of the iron core) to form ⊂-shaped iron cores 2.

Except for the iron cores 2 stamped from the sheet of silicon steel 1, there are remaining portions (portions arranged on left and right sides of the adjacent iron cores 2 and portions arranged on upper and lower sides of the adjacent as a scrap iron 3.

The scrap iron causes a manufacturing cost of the iron core 2 to be increased, and thus the price competitiveness of the iron core built in a product (e.g., transformer) is decreased.

In order to laminate a predetermined number of formed iron cores 2, a subsequent process of thermally bonding the formed iron cores 2 through argon welding and so on is required, after the iron cores 2 are laminated, which decreases its workability and productivity.

Also, the bonded portion of the iron core 2 may interrupt an electric flow or cause electric interference to deteriorate the electric characteristic of the iron core, and this degrades the quality and reliability of the product.

E-shaped iron cores and I-shaped iron cores formed according to the prior art as shown in FIG. 2 prevent the sheet of silicon steel 1 from being scraped when the E-shaped iron cores 4 and the I-shaped iron cores 5 are stamped from the sheet of silicon steel 1 by using a single mold punch and die (not shown), and this can reduce the manufacturing cost thereof.

However, since the pitch of the mold punch for stamping the E-shaped iron cores 4 and the I-shaped iron cores 5 has a long interval L, the entire size of the mold punch and die is increased. This requires the use of a large press to form the iron cores, and thus the stamping speed of the press is lowered to decrease its productivity and price competitiveness.

When the E-shaped iron cores 4 are stamped from the sheet of silicon steel 1, one E-shaped iron core 4 is upwardly stamped, while another adjacent E-shaped iron core 4 is downwardly stamped. Therefore, a process of taking out the E-shaped iron core 4 from the die becomes complicated to decrease its workability.

### DISCLOSURE

### Technical Problem

Accordingly, the present invention has been made to solve the above-mentioned problems occurring in the prior art, and an object of the present invention is to provide an iron core, and a mold and a method for forming and laminating the same, whereby when an iron core is formed, an E-shaped iron core and a pair of ⊂-shaped iron cores, which are arranged on both sides of the E-shaped iron core, are simultaneously stamped from a sheet of silicon steel, thereby preventing the sheet of expensive silicon steel from being scraped and thus reducing a manufacturing cost.

Another object of the present invention is to provide an iron core, and a mold and a method for forming and laminating the same, whereby iron cores are downwardly stamped from a sheet of silicon steel by a mold punch and a die, and thus the stamped iron cores can be easily taken out from the die.

Still another object of the present invention is to provide an iron core, and a mold and a method for forming and laminating the same, whereby when iron cores are stamped from a sheet of silicon steel, a predetermined number of iron cores can be laminated, without performing a subsequent process, thereby shortening the number of operations.

Yet still object of the present invention is to provide an iron core, and a mold and a method for forming and laminating the same, whereby since the pitch of a mold punch and a die for stamping iron cores has a decreased interval, the entire size of the mold punch and die is increased, thereby increasing a stamping speed of a press.

Yet still another object of the present invention is to provide an iron core, and a mold and a method for forming and laminating the same, whereby a subsequent process of thermally bonding a predetermined number of iron cores which are separately formed and laminated is not required, and the magnetic flux density of iron cores is increased as compared with conventional E-shaped and I-shaped electric characteristics of the iron cores.

Additional advantages, objects, and features of the invention will be set forth in part in the description which follows and in part will become apparent to those having ordinary skill in the art upon examination of the following or may be learned from practice of the invention.

### Technical Solution

In order to accomplish these objects, there is provided an iron core comprising an E-shaped iron core having side legs symmetrically formed on both sides thereof and a center leg formed between the side legs and coupled to a bobbin around which a coil is wound; and a pair of ⊂-shaped iron cores each having a long leg formed corresponding to the side leg of the E-shaped iron core, and a short leg formed corresponding to the center leg of the E-shaped iron core; wherein the E-shaped iron core and the pair of ⊂-shaped iron cores, which are arranged on both sides of the E-shaped iron core so that a stamped groove formed between the side leg and the center leg of the E-shaped iron core corresponds to the short leg of the ⊂-shaped iron core and a stamped groove formed between the legs of the ⊂-shaped iron core corresponds to the side leg of the E-shaped iron core, are stamped from a sheet of silicon steel.

According to another aspect of the present invention, there is provided a mold for forming and laminating iron cores from a sheet of silicon steel, the mold comprising a mold punch having embossing punches for forming embossed portions to closely laminate the iron cores, a pair of ⊂-shaped iron core forming punches for stamping a pair of ⊂-shaped iron cores and having a laminating punch on a bottom surface thereof, and an E-shaped iron core forming punch for stamping an E-shaped iron core between the pair of ⊂-shaped iron cores from the sheet of silicon steel and having a laminating punch on a bottom surface thereof; and a die having recessed portions formed corresponds a first receiving portion, formed in a shape corresponding to the pair of ⊂-shaped iron core forming punches, for receiving the pairs of ⊂-shaped iron cores being accumulated and laminated therein, and a second receiving portion, formed in a shape corresponding to the E-shaped iron core forming punch, for receiving the E-shaped iron cores being accumulated and laminated therein; wherein the pairs of ⊂-shaped iron cores and the E-shaped iron cores are stamped from the sheet of silicon steel in association with one another, to prevent the sheet of silicon steel from being scraped, and after the iron cores are stamped, a predetermined number of the E-shaped iron cores and pairs of the ⊂-shaped iron cores are accumulated in the first and second receiving portions, and then laminated by pressing the embossed portions of the iron cores through the laminating press punches.

Preferably, the E-shaped iron cores and the pairs of the ⊂-shaped iron cores are stamped by pressing down the sheet of silicon steel being transferred on the die using the mold punch.

According to still another aspect of the present invention, there is provided a method for laminating iron cores stamped from a sheet of silicon steel using a press mold, the method comprising a first step of forming embossed portions on the sheet of silicon steel; a second step of stamping pairs of ⊂-shaped iron cores from the sheet of silicon steel using a ⊂-shaped iron core forming punch and die having a shape corresponding to the pairs of ⊂-shaped iron cores and stamping E-shaped iron cores arranged between the pairs of ⊂-shaped iron cores from the sheet of silicon steel using an E-shaped iron core forming punch and die having a shape corresponding to the E-shaped iron cores; a third step of accumulating the pairs of the ⊂-shaped iron cores and the E-shaped iron cores in a first receiving portion and a second receiving portion formed in the die in shapes corresponding to the pairs of the ⊂-shaped iron cores and the E-shaped iron cores, respectively; and a fourth step of laminating a predetermined number of those of the ⊂-shaped iron cores by pressing the embossed portions of the pairs of the ⊂-shaped iron cores and the E-shaped iron cores, which are respectively accumulated in the first and second receiving portions, by using laminating press punches each being provided on bottom surfaces of the ⊂-shaped iron core forming punch and the E-shaped iron core forming punch.

The iron core may further include means for coupling the E-shaped iron core and the pair of ⊂-shaped iron cores, the coupling means having recessed portions formed on a center leg of the E-shaped iron core, an engaging boss formed on each short leg of the ⊂-shaped iron cores and engaged with the recessed portion, an engaging boss formed on each side leg of the E-shaped iron core, and a recessed portion formed on each long leg of the ⊂-shaped iron cores and engaged with the engaging boss.

The mold punches and dies may be arranged in 2, 4, 6 or 8 rows, so that the E-shaped iron cores and the pairs of ⊂-shaped iron cores are simultaneously stamped in 2, 4, 6 or 8 pairs from the sheet of silicon steel.

### ADVANTAGEOUS EFFECTS

The iron core, and the mold and the method for forming and laminating the same according to the present invention, as described above, have the following advantages.

When the iron core is formed, the E-shaped iron core and the pair of ⊂-shaped iron cores, which are arranged on both sides of the E-shaped iron core, are simultaneously stamped from the sheet of silicon steel, thereby preventing the sheet of expensive silicon steel from being scraped and thus reducing the manufacturing cost.

The press speed for stamping the iron core can be increased to improve its workability and productivity, and a predetermined number of iron cores can be laminated, without performing a subsequent process.

As the iron cores are downwardly stamped from the mold punch and die, the stamped iron core can be easily taken out from the die.

Since the pitch of the punch for stamping the iron core is decreased as compared with a conventional iron core composed of E-shaped and I-shaped iron cores, a small press is required, and thus the stamping speed is increased to improve its productivity.

In addition, no subsequent process of thermally bonding a predetermined number of iron cores which are separately formed and laminated is required, and the magnetic flux density of the iron core is increased as compared with the conventional iron core composed of the E-shaped and I-shaped iron cores, thereby improving the electric characteristic of the iron core and thus its reliability.

### DESCRIPTION OF DRAWINGS

The above and other objects, features and advantages of the present invention will be more apparent from the following detailed description taken in conjunction with the accompanying drawings, in which:

FIG. 1 is a perspective view illustrating the process of forming a ⊂-shaped iron core from a sheet of silicon steel according to the related art.

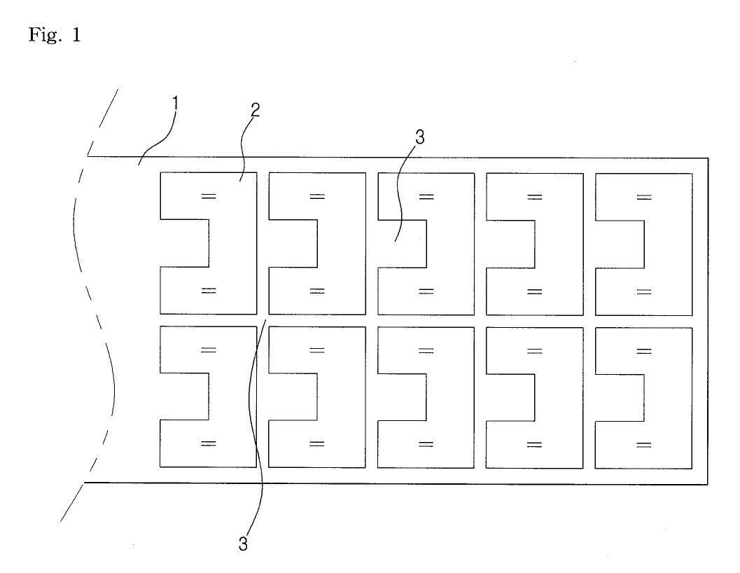

FIG. 2 is a perspective view illustrating the process of forming E-shaped iron cores and I-shaped iron cores from a sheet of silicon steel according to the related art.

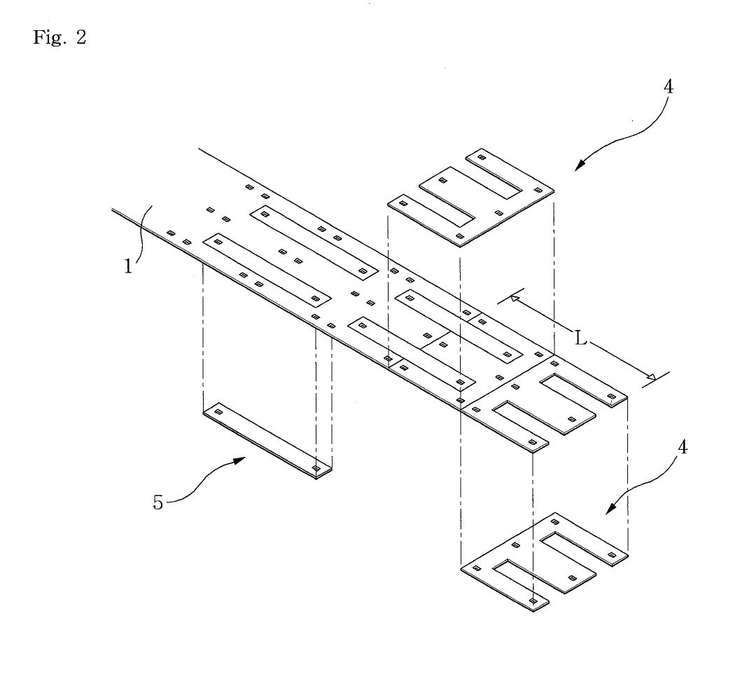

FIG. 3 is a perspective view illustrating an iron core according to the present invention.

FIG. 4 is a perspective view illustrating a mold punch and die used to form and laminate iron cores according to the present invention.

FIG. 5 is a perspective view illustrating the process of forming E-shaped iron cores and pairs of ⊂-shaped iron cores, which are arranged on both sides of the E-shaped iron core, are simultaneously stamped from a sheet of silicon invention.

FIG. 6 is a perspective view illustrating iron cores formed and laminated according to the present invention.

FIG. 7 is an alternative embodiment of an iron core according to the present invention.

### BEST MODEL

Hereinafter, preferred embodiments of the present invention will be described in detail with reference to the accompanying drawings.

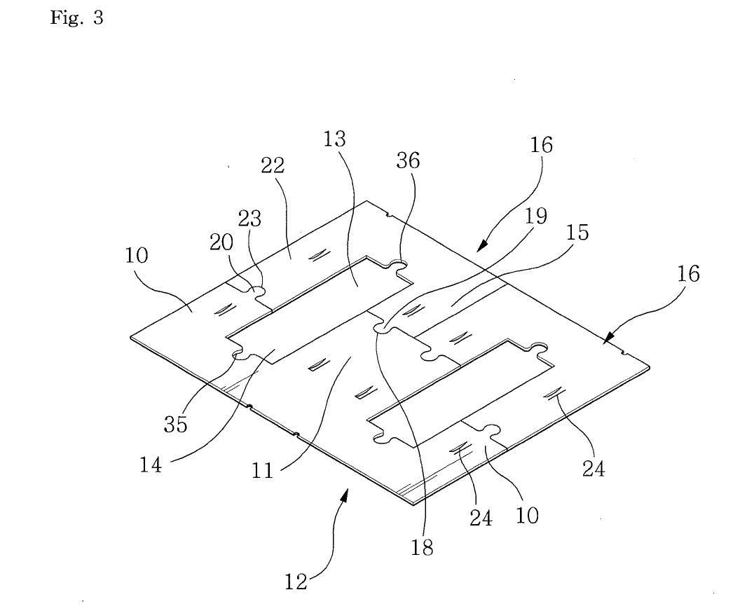

Referring to FIGS. 3 thorough 6, in the case in which an iron core according to the present invention is formed, an E-shaped iron core 12 and a pair of Z-shaped iron cores 16, which are arranged on both sides of the E-shaped iron core 12, are simultaneously stamped from a sheet of silicon steel 17 having a predetermined thickness (in general, 0.5 mm, or 0.1 to 0.35 mm) by using a press mold (not shown), so as to prevent the sheet of silicon steel 17 from being scraped.

The iron core includes the E-shaped iron core 12 having side legs 10 symmetrically formed on both sides thereof, a center leg 11 formed between the side legs 10 and coupled to a bobbin (not shown) around which a coil is wound, and stamped grooves 14 formed between the side legs 10 and the center leg 11.

The iron core also includes the pair of ⊂-shaped iron cores 16 each having a long leg 22 formed corresponding to the side leg 10 of the E-shaped iron core 12, a short leg 15 formed corresponding to the center leg 11 of the E-shaped iron core 12, and a stamped groove 13 corresponding to the stamped groove 14 of the E-shaped iron core 12. Since both legs 15 and 22 of the ⊂-shaped iron core 16 have different lengths, the ⊂-shaped iron core 16 has an asymmetric cross section.

The iron core also includes means for coupling the of ⊂-shaped iron cores 16. The coupling means has recessed portions 18 formed on the center leg 11 of the E-shaped iron core 12, an engaging boss 19 formed on each short leg 15 of the ⊂-shaped iron cores 16 and engaged with the recessed portion 18, an engaging boss 20 formed on each side leg 10 of the E-shaped iron core 12, and a recessed portion 23 formed on each long leg 22 of the ⊂-shaped iron cores 16 and engaged with the engaging boss 20.

Reference numeral 35 indicates a recessed portion inevitably formed on the E-shaped iron core 12 when the short leg 15 of the ⊂-shaped iron core 16 is stamped from the sheet of silicon steel 17, and reference numeral 36 indicates a recessed portion inevitably formed on the ⊂-shaped iron core 16 when the side leg 10 of the E-shaped iron core 12 is stamped from the sheet of silicon steel 17.

The mold for forming and laminating the iron core according to the present invention can prevent the silicon steel 17 from being scraped when the E-shaped iron core 12 and the pair of ⊂-shaped iron cores 16, which are arranged to engage with each other, are stamped from the sheet of silicon steel 17.

In the case in which the ⊂-shaped iron cores 16 and the E-shaped iron cores 12 are stamped and then accumulated in first and second receiving portions 32 and 33, the embossed portion 24 of the ⊂-shaped iron core 16 and the embossed portion 24 of the E-shaped iron core 12 are pressed by laminating press punches 26 and 28 to laminate the ⊂-shaped iron cores 16 and the E-shaped iron cores 12 in a predetermined number.

The mold for forming and laminating the iron core according to the present invention includes a mold punch 30 having through-hole forming punches 41 for punching through-holes 50 in the sheet of silicon steel 17, embossing punches 25 for forming embossed portions 24 to closely laminate the iron cores, a pair of ⊂-shaped iron core forming punches 27 for stamping the ⊂-shaped iron core 16 and bottom surface thereof, and an E-shaped iron core forming punch 29 for stamping the E-shaped iron core 12 between the pair of ⊂-shaped iron cores 16 from the sheet of silicon steel 17 and having a laminating punch 28 on a bottom surface thereof.

Also, the mold for forming and laminating the iron core according to the present invention includes a die 34 having through-holes 42 formed corresponding to the through-hole forming punches 41, recessed portions 31 formed corresponding to the embossing punches 25, a first receiving portion 32 formed in a shape corresponding to the ⊂-shaped iron core forming punches 27, in which the ⊂-shaped iron cores 16 are laminated, and a second receiving portion 33 formed in a shape corresponding to the E-shaped iron core forming punch 29, in which the E-shaped iron cores 12 are received and laminated.

Reference numerals 39 and 39a indicate a punch and a through-hole 40a used to stamp the recessed portion 23 of the ⊂-shaped iron core 16, and reference numerals 40 and 40a indicate a punch and a through-hole 40a used to stamp the recessed portion 18 of the E-shaped iron core 12.

The process of stamping the iron core according to the present invention will now be described in detail with reference to the accompanying drawings.

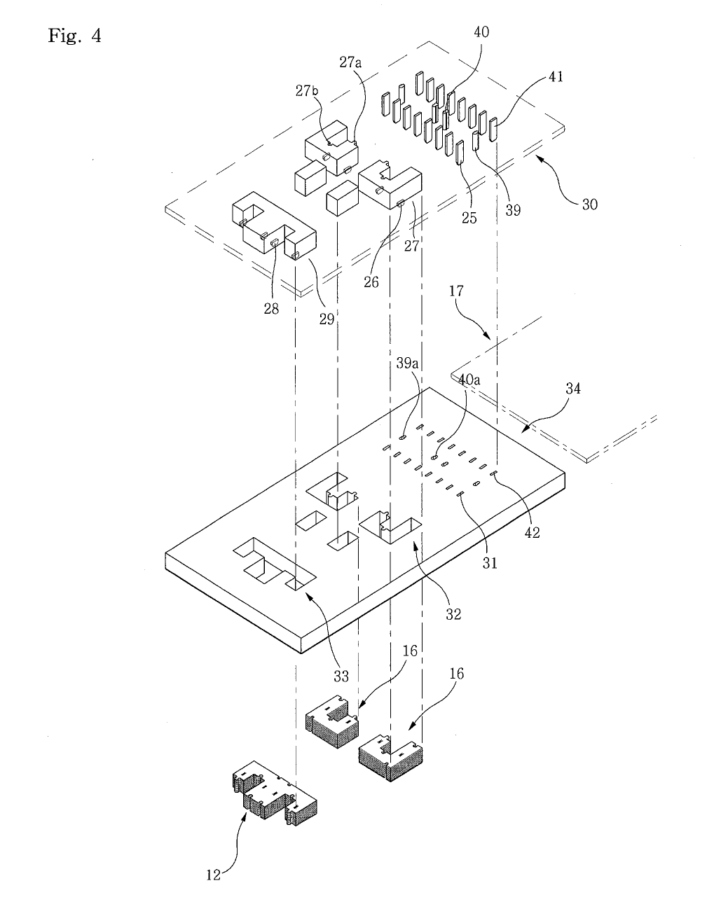

When the sheet of silicon steel 17 is transferred onto the upper surface of the die 34 by transferring means (not shown) (indicated by an imaginary line in FIG. 4), the ⊂-shaped iron cores 16 may be stamped from the sheet of the silicon steel 17 by the structure comprising the first receiving portion 32 formed in the die 34 in the shape corresponding to the ⊂-shaped iron core 16, and the ⊂-shaped iron core forming punch 27 formed in the mold punch 30 in the shape corresponding to the first receiving portion 32.

The E-shaped iron core 12 may be stamped from the sheet of the silicon steel 17 by the structure comprising the second receiving portion 33 formed in the die 34 in the shape corresponding to the E-shaped iron core 12, and the E-shaped formed in the mold punch 30 in the shape corresponding to the second receiving portion 33.

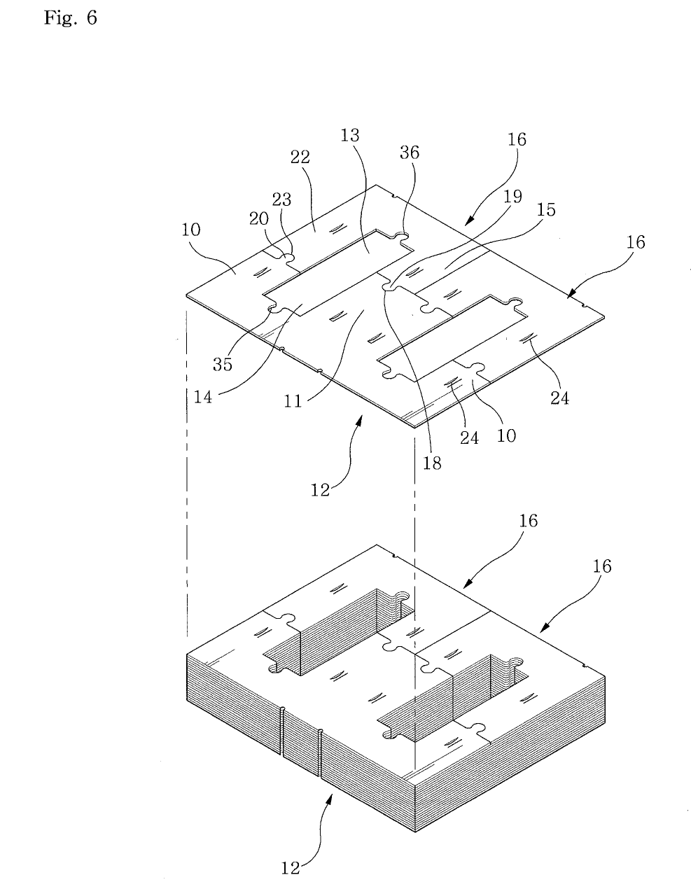

As shown in FIGS. 3 and 6, the E-shaped iron core 12 and the pair of ⊂-shaped iron cores 16 are stamped from the sheet of the silicon steel 17 by using the mold punch 30 and the die 34.

Thus, when the iron core is stamped from the sheet of silicon steel 17, the sheet of expensive silicon steel is prevented from being scraped and thus the manufacturing cost is reduced.

The means of transferring the sheet of silicon steel 17 and the means of driving the mold punch 30 and the die 34 are well known in the art, and the detailed explanation of the structure and operation thereof will be omitted.

The process of forming the iron core using the mold according to the present invention will now be described in detail with reference to the accompanying drawings.

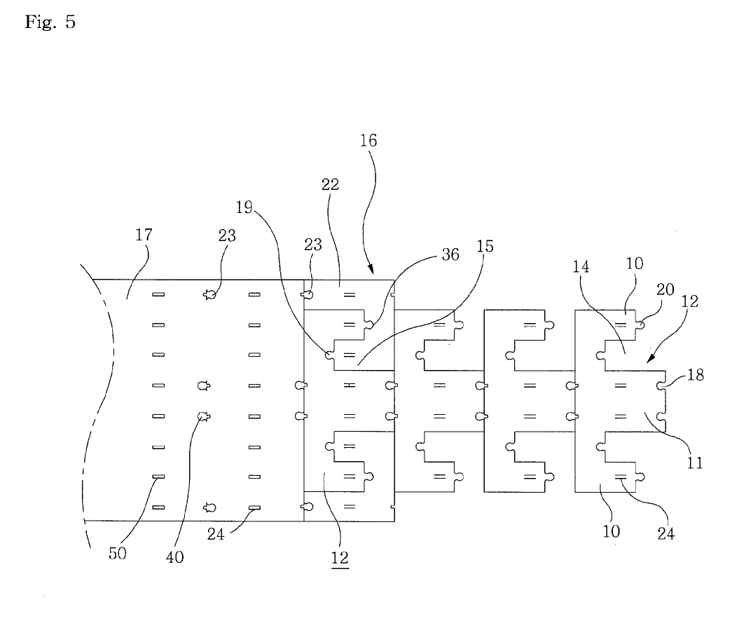

As shown in FIGS. 4 through 6, when the iron core is stamped from the sheet of the silicon steel 17, the E-shaped iron core 12 and the pair of ⊂-shaped iron cores 16, which are separately stamped, are laminated and set in a predetermined number, thereby increasing its workability and productivity.

Specifically, when the sheet of silicon steel 17 is transferred onto the upper surface of the mold punch 30 (indicated by an imaginary line in FIG. 4), the sheet of the silicon steel 17 is provided with the through-holes 50 by the structure comprising the through-hole forming punch 41 formed in the mold punch 30 and the through-holes 39a formed in the die 34 in the shape corresponding to the through-hole forming punch 41. The through-holes 50 can prevent the embossed portions 24 from spreading when the iron core is stamped.

The long legs 22 of the ⊂-shaped iron cores portions 23 by the structure comprising the punch 39 formed in the mold punch 30 and the through-holes 39a formed in the die 34 in the shape corresponding to the punch 39.

At the same time, the recessed portions 18 are formed on the center leg 11 of the E-shaped iron core 12 by the structure comprising the punch 40 formed in the mold punch 30 and the through-holes 40a formed in the die 34 in the shape corresponding to the punch 40.

The sheet of silicon steel 17 is provided with the embossed portions 24 by the structure comprising the embossing punch 25 of the mold punch 30 and the recessed portions 31 formed on the die 34 in the shape corresponding to the embossing punch 25.

The ⊂-shaped iron cores 16 are stamped from the sheet of the silicon steel 17 by the structure comprising the ⊂-shaped iron core forming punches 27 of the mold punch 30 and the first receiving portion 32 formed in the die 34 in the shape corresponding to the punch 27.

The stamped grooves 14 of the E-shaped iron core 12 are provided with the recessed portions 35 by the bosses 27a of the ⊂-shaped iron core forming punches 27, and the side legs 10 of the E-shaped iron core 12 are provided with the bosses 20 by the recessed grooves 27b of the ⊂-shaped iron core forming punches 27.

After the ⊂-shaped iron cores 16 are separately stamped from the sheet of silicon steel 17, and are laminated in the first receiving portion 32, the embossed portions 24 of the ⊂-shaped iron core 16 are pressed by the laminating press punch 26 protruding from the bottom surface of the punch 27, thereby laminating the iron cores in a predetermined number.

In this case, the ⊂-shaped iron cores 16 laminated in the predetermined number can be removed from the first receiving portion 32 of the die 34 by the driving means (not shown).

The E-shaped iron core 12 is stamped from the silicon structure comprising the E-shaped iron core forming punch 29 of the mold punch 30 formed in the shape corresponding to the E-shaped iron core 12, and the second receiving portion 33 formed in the die 34 in the shape corresponding to the punch 29.

After the E-shaped iron cores 12 are separately stamped from the sheet of silicon steel 17, and are laminated in the second receiving portion 33, the embossed portions 24 of the E-shaped iron core 12 are pressed by the laminating press punch 28 protruding from the bottom surface of the punch 29, thereby laminating the E-shaped iron cores in a predetermined number.

In this case, the E-shaped iron cores 12 laminated in the predetermined number can be removed from the second receiving portion 33 of the die 34 by the driving means (not shown).

The sheet of the silicon steel 17 is provided with the through-holes (not shown) by the structure comprising the through-hole forming punch 41 formed in the mold punch 30 and the through-holes 42 formed in the die 34 in the shape corresponding to the through-hole forming punch 41. The through-holes can prevent the embossed portions 24 of the E-shaped iron core 12 from spreading when the embossed portions of the E-shaped iron core 12 are pressed by the laminating pressing punch 28.

After the ⊂-shaped iron cores 16 and the E-shaped iron cores 12 are separately formed and stamped from the sheet of silicon steel, the iron cores 16 and 12 are laminated in the first and second receiving portions 32 and 33, without carrying out a subsequent bonding process, thereby increasing its workability and productivity.

When the E-shaped iron cores 12 and the ⊂-shaped iron cores 16 are stamped from the sheet of silicon steel and are laminated, the recessed portions of the E-shaped iron cores 12 are in close contact with the bosses 19 of the ⊂-shaped iron cores 16, thereby increasing the magnetic flux density of the iron core. Therefore, there is improved as compared with a conventional iron core consisting of E and I-shaped iron cores 4 and 5.

Although not shown in the accompanying drawings, the mold punches 30 and the dies 34 are arranged in 2, 4, 6 or 8 rows, so that the E-shaped iron cores 12 and the ⊂-shaped iron cores 16 can be simultaneously stamped in 2, 4, 6 or 8 pairs from the sheet of silicon steel 17, thereby increasing its workability and productivity and thus decreasing the manufacturing cost.

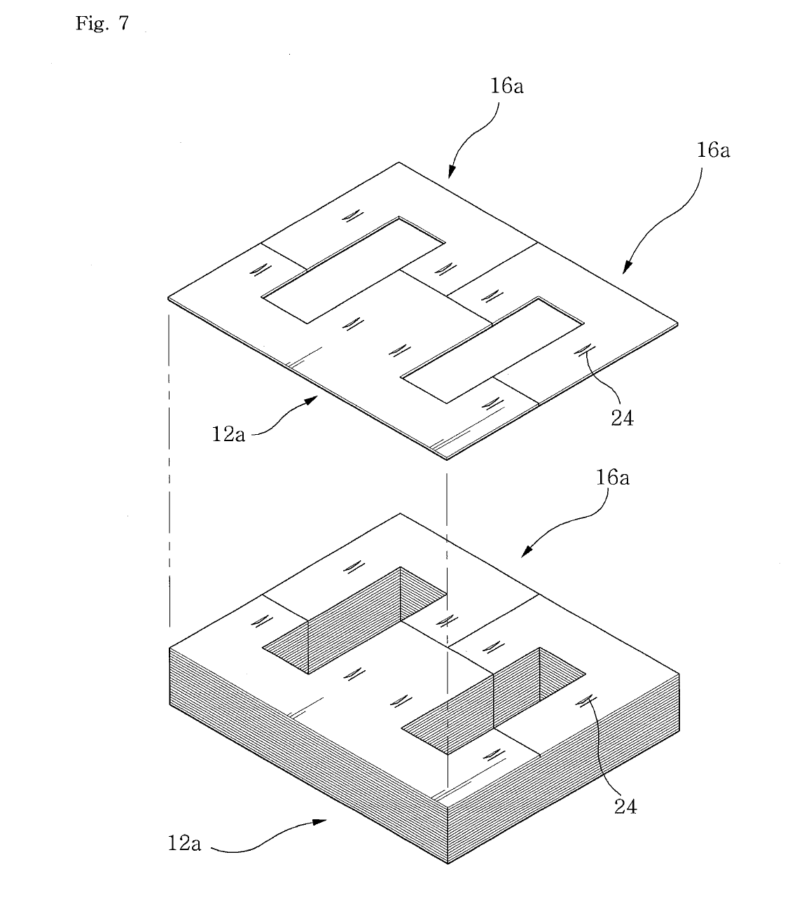

As shown in FIG. 7, according to the iron core of the present invention, when an E-shaped iron cores 12a is stamped from a sheet of silicon steel 17 by using a mold punch and die (not shown), ⊂-shaped iron cores 16a can be stamped from sheets of silicon steel 17 arranged on both sides of the sheet of silicon steel 17 by using a mold punch and die (not shown).

After the E-shaped iron cores 12a and the ⊂-shaped iron cores 16a are stamped, the laminated iron cores are thermally bonded.

The stamping process of the E-shaped iron cores 12a and the ⊂-shaped iron cores 16a is substantially similar to that shown in FIG. 3, and thus the detailed explanation thereof will be omitted.

### INDUSTRIAL APPLICABILITY

As described above, the iron core, and the mold and the method for forming and laminating the same according to the present invention, as described above, have the following advantages.

When the iron core is formed, the E-shaped iron core and the pair of ⊂-shaped iron cores, which are arranged on both sides of the E-shaped iron core, are simultaneously stamped from the sheet of silicon steel, thereby preventive steel from being scraped and thus reducing the manufacturing cost.

The press speed for stamping the iron core can be increased to improve its workability and productivity, and a predetermined number of iron cores can be laminated, without performing a subsequent process.

As the iron cores are downwardly stamped from the sheet of silicon steel by using the mold punch and die, the stamped iron core can be easily taken out from the die.

Since the pitch of the punch for stamping the iron core is decreased as compared with a conventional iron core composed of E-shaped and I-shaped iron cores, a small press is required, and thus the stamping speed is increased to improve its productivity.

In addition, no subsequent process of thermally bonding a predetermined number of iron cores which are separately formed and laminated is required, and the magnetic flux density of the iron core is increased as compared with the conventional iron core composed of the E-shaped and I-shaped iron cores, thereby improving the electric characteristic of the iron core and thus its reliability.

Although preferred embodiments of the present invention have been described for illustrative purposes, those skilled in the art will appreciate that various modifications, additions and substitutions are possible, without departing from the scope and spirit of the invention as disclosed in the accompanying claims.

1. An iron core comprising:
an E-shaped iron core having side legs symmetrically formed on both sides thereof and a center leg formed between the side legs and coupled to a bobbin around which a coil is wound; and
a pair of ⊂-shaped iron cores each having a long leg formed corresponding to the side leg of the E-shaped iron core, and a short leg formed corresponding to the center leg of the E-shaped iron core;
wherein the E-shaped iron core and the pair of ⊂-shaped iron cores, which are arranged on both sides of the E-shaped iron core so that a stamped groove formed between the side leg and the center leg of the E-shaped iron core corresponds to the short leg of the ⊂-shaped iron core and a stamped groove formed between the legs of the ⊂-shaped iron core corresponds to the side leg of the E-shaped iron core, are stamped from a sheet of silicon steel.

2. The iron core as claimed in claim 1, further comprising means for coupling the E-shaped iron core and the pair of ⊂-shaped iron cores, the coupling means having recessed portions formed on a center leg of the E-shaped iron core, an engaging boss formed on each short leg of the ⊂-shaped iron cores and engaged with the recessed portion, an engaging boss formed on each side leg of the E-shaped iron core, and a recessed portion formed on each long leg of the ⊂-shaped iron cores and engaged with the engaging boss.

3. The iron core as claimed in claim 1, wherein the E-shaped iron core and the ⊂-shaped iron cores have a thickness of 0.5 mm.

4. The iron core as claimed in claim 1, wherein the E-shaped iron core and the ⊂-shaped iron cores have a thickness of 0.1 to 0.35 mm.

5. A mold for forming and laminating iron cores from a sheet of silicon steel, the mold comprising: a mold punch having embossing punches for forming embossed portions to closely laminate the iron cores, a pair of ⊂-shaped iron core forming punches for stamping a pair of ⊂-shaped iron cores and having a laminating punch on a bottom surface thereof, and an E-shaped iron core forming punch for stamping an E-shaped iron core between the pair of ⊂-shaped iron cores from the sheet of silicon steel and having a laminating punch on a bottom surface thereof; and a die having recessed portions formed corresponding to the embossing punches, a first receiving portion, formed in a shape corresponding to the pair of ⊂-shaped iron core forming punches, for receiving the pairs of ⊂-shaped iron cores being accumulated and laminated therein, and a second receiving portion, formed in a shape corresponding to the E-shaped iron core forming punch, for receiving the E-shaped iron cores being accumulated and laminated therein; wherein the pairs of ⊂-shaped iron cores and the E-shaped iron cores are stamped from the sheet of silicon steel in association with one another, to prevent the sheet of silicon steel from being scraped, and after the iron cores are stamped, a predetermined number of the E-shaped iron cores and pairs of the ⊂-shaped iron cores are accumulated in the first and second receiving portions, and then laminated by pressing the embossed portions of the iron cores through the laminating press punches.

6. The mold as claimed in claim 5, wherein the mold punches and the dies are arranged in 2, 4, 6 or 8 rows, so that the E-shaped iron cores and the ⊂-shaped iron cores are simultaneously stamped in 2, 4, 6 or 8 pairs from the sheet of silicon steel.

7. The mold as claimed in claim 5, wherein the E-shaped iron cores and the pairs of ⊂-shaped iron cores are stamped by pressing down the sheet of silicon steel being transferred on the die using the mold punch.

8. A method for laminating iron cores stamped from a sheet of silicon steel using a press mold, the method comprising:
a first step of forming embossed portions on the sheet of silicon steel;
a second step of stamping pairs of ⊂-shaped iron cores from the sheet of silicon steel using a ⊂-shaped iron core forming punch and die having a shape corresponding to the pairs of ⊂-shaped iron cores and stamping E-shaped iron cores arranged between the pairs of ⊂-shaped iron cores from the sheet of silicon steel using an E-shaped iron core forming punch and die having a shape corresponding to the E-shaped iron cores;
a third step of accumulating the pairs of the ⊂-shaped iron cores and the E-shaped iron cores in a first receiving portion and a second receiving portion formed in the die in shapes corresponding to the pairs of the ⊂-shaped iron cores and the E-shaped iron cores, respectively; and
a fourth step of laminating a predetermined number of the E-shaped iron cores and the pairs of the ⊂-shaped iron cores by pressing the embossed portions of the pairs of the ⊂-shaped iron cores and the E-shaped iron cores, which are respectively accumulated in the first and second receiving portions, by using laminating press punches each being provided on bottom surfaces of the ⊂-shaped iron core forming punch.
